(19) United States
(12) Patent Application Publication
(10) Pub. No.: US 2006/0291718 A1
(43) Pub. Date: Dec. 28, 2006

(54) Method for generating grid using computer

(75) Inventor: Koichi Shimizu, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/237,844

(22) Filed: Sep. 29, 2005

(30) Foreign Application Priority Data
Jun. 27, 2005 (JP) 2005-186748

(51) Int. Cl. G06K 9/00

(52) U.S. Cl. 382/154

(57) ABSTRACT

A base grid line running through each vertex of a component is generated by a computer. When the interval between the base grid lines is shorter than the shortest grid interval designated by a user, the relevant base grid line is automatically deleted. According to the number of grid lines designated by the user, one or a plurality of auxiliary grid line(s) is automatically inserted between the base grid lines.

### BACKGROUND OF THE INVENTION

1. Field of the Invention

The present invention relates to a device, a method, and a program for generating a grid for the use of analyzing a physical quantity relating to the geometry of an object by using a computer.

2. Description of the Related Art

In recent years, a technology for an analysis (or simulation) of a physical quantity relating to the geometry of an object using a computer has been developed. For example, such analyses as three-dimensional fluid analysis, thermal analysis, and electromagnetic field analysis of the surroundings of a target object.

In such kinds of analysis, a grid (or a mesh), as shown in FIG. 1, is often used. A rectangular grid is used for a two-dimensional model, and a cuboid grid is used for a three-dimensional model. For an analysis of the three-dimensional model, projections of the X-Y plane, the Y-Z plane and the Z-X plane can be of use.

Grids are generated in consideration of the orientation or posture of a target object (hereinafter referred to as a “component”) defined by a computer. The physical quantity relating to the geometry of the component is analyzed by providing parameters to each cell acquired from the grids and by solving equations corresponding to the model to be analyzed. In order to enhance arithmetic accuracy of the analysis, it is desirable to generate grid lines, which define each cell, so as to run through a feature point (for example, a vertex) of the component geometry at this point.

Grids used for the above analysis are, for example, generated as by the following procedure. First, a plurality of polygon data for specifying the geometry of the component is generated, and as shown in FIG. 2A, grid lines running through the vertices of each polygon are generated. In this specification, grid lines generated in such a way are referred to as the “base grid lines”. Next, if required, new grid lines are generated between the base grid lines as shown in FIG. 2B. Such grid lines inserted between the base grid lines are referred to as the “auxiliary grid lines”. The base grid lines are automatically generated by detecting the vertex coordinates of each polygon; however, the auxiliary grid lines are set manually by a user using a keyboard or a mouse etc.

In Patent Document 1 (Japanese laid-open unexamined patent publication No. 11-259684 (especially FIG. 1, paragraphs 0021-0027 of the specification)), a technology of a device for generating a mesh for analyzing a three-dimensional geometry model and effective performance of the generation is described.

In the above analysis, the grid lines (including the base grid lines and the auxiliary grid lines) are placed at even intervals, and, when the aspect ratio of each cell is favorable, arithmetic accuracy can be improved. Here, “the aspect ratio of a cell” means the ratio of the lengths of the X direction, the Y direction and the Z direction (the ratio of the length of the X direction and the Y direction in a two-dimensional model), and the arithmetic accuracy is higher as the ratio of one cell is closer to that of the others.

As explained above, the base grid line can be automatically generated. However, when automatically generating the base grid line, the intervals of the grid lines may be excessively narrow for some components, depending on the geometry of the component. In such a case, cells with a poor aspect ratio are generated, and consequently, the arithmetic accuracy is reduced. It is possible to improve the aspect ratio by generating auxiliary grid lines on the basis of the narrowest base grid intervals. However, by so doing, the geometry of some components may require generation of an enormous number of auxiliary grid lines, resulting in an increase in the amount of calculation.

The auxiliary grid lines, as explained above, require manual setting by a user. At such a time, the user has to set each auxiliary grid line one by one using a keyboard, a mouse and so forth. Thus, the task is time-consuming and troublesome.

### SUMMARY OF THE INVENTION

It is an object of the present invention to provide a method for facilitated generation of a grid, which bears a highly precise analysis result in a technology for analyzing a physical quantity relating to the geometry of an object by using a computer.

The grid generation method of the present invention, which generates a grid for the use of an analysis of a physical quantity relating to the geometry of an object using a computer, the method comprising: generating a plurality of base grid elements, each of which passes through each of a plurality of feature points, which specify the geometry of the object, and generating an auxiliary grid element of the number designated by grid element number information, and arranging the generated auxiliary grid element between the base grid elements.

According to the method, after generating the base grid elements, by inputting the grid element number information without individually setting the auxiliary grid elements, the auxiliary grid elements are generated in the number a user requests, and are arranged between the base grid elements. The grid element is a concept of a grid line in a two-dimensional model and of a grid plane in a three-dimensional model.

In the above grid generation method, the base grid element can be deleted or added according to the shortest interval information designating the shortest interval between the base grid elements. According to the method, the grid interval will not fall below a prescribed value (i.e. interval designated by the shortest interval information). Thus, deterioration of the aspect ratio of the grid can be prevented. Consequently, the accuracy of analysis is improved.

According to the present invention, generation of a grid, which produces highly accurate analysis results in an analysis technology for a physical quantity relating to the geometry of an object using a computer, can be facilitated.

### BRIEF DESCRIPTION OF THE DRAWINGS

FIG. 1 is a diagram explaining a grid;

FIG. 2 is a diagram explaining a procedure to generate a grid line with a conventional technology;

FIG. 3 is a diagram showing a system environment for implementing the present invention;

FIGS. 4A and 4B are diagrams explaining the background of the present invention;

FIG. 5A-5C are diagrams explaining overviews of the grid generation method of the embodiment;

FIG. 6 is a flowchart showing an overview of the grid generation method of the embodiment;

FIG. 7A-7C are diagrams explaining generation/deletion/addition of the base grid line;

FIG. 8 is a practical example of a dialog screen for setting the base grid interval;

FIG. 9A-9D are diagrams explaining generation/deletion/addition of the auxiliary grid line;

FIG. 10 is a practical example of the dialog screen for setting the number of grid lines;

FIG. 11 is a flowchart of processing for generating the base grid;

FIG. 12A is a practical example of a grid table;

FIG. 12B is a practical example of a priority table;

FIG. 13 is a flowchart of processing for addition/deletion of the base grid;

FIG. 14 is a flowchart of processing for addition/deletion of the base grid line in consideration of the priority of the component;

FIG. 15 is a flowchart of processing for increasing the number of the auxiliary grid lines;

FIG. 16 is a flowchart of processing for decreasing the number of the auxiliary grid lines;

FIG. 17 is a flowchart of processing for drawing a grid after a change in the interval between the base grid lines; and

FIG. 18 is a diagram explaining a method for providing the program relating to the present invention.

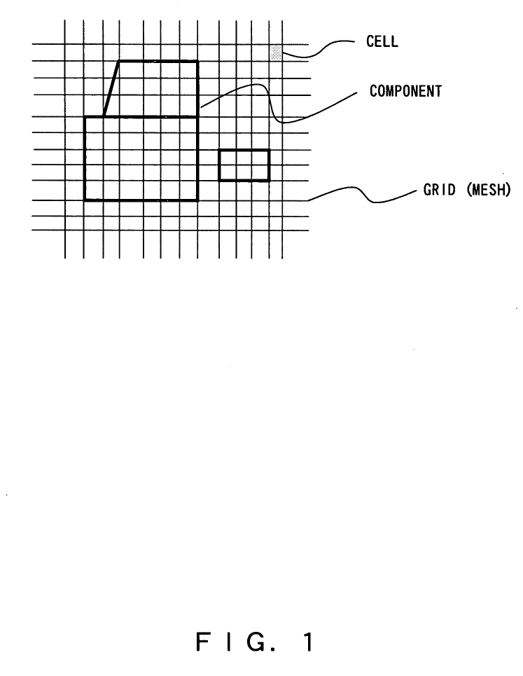

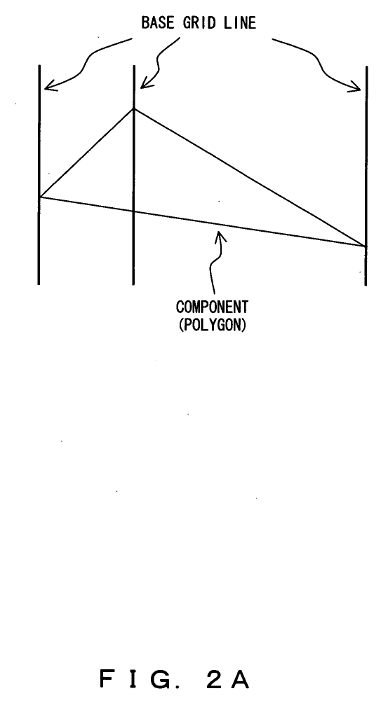

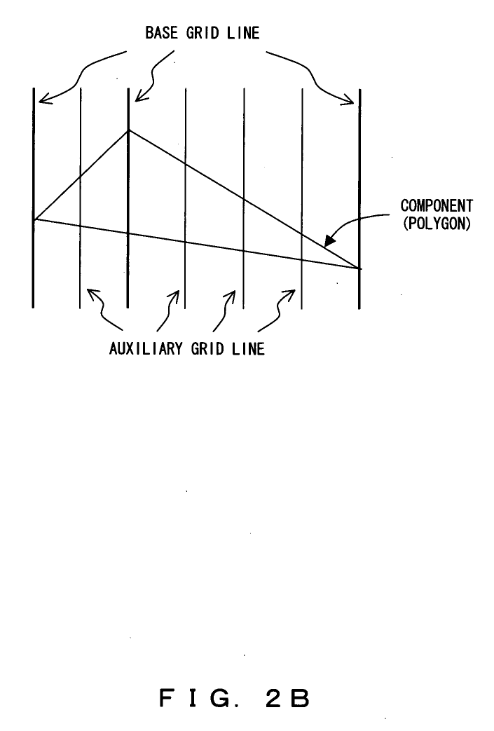

### DESCRIPTION OF THE PREFERRED EMBODIMENT

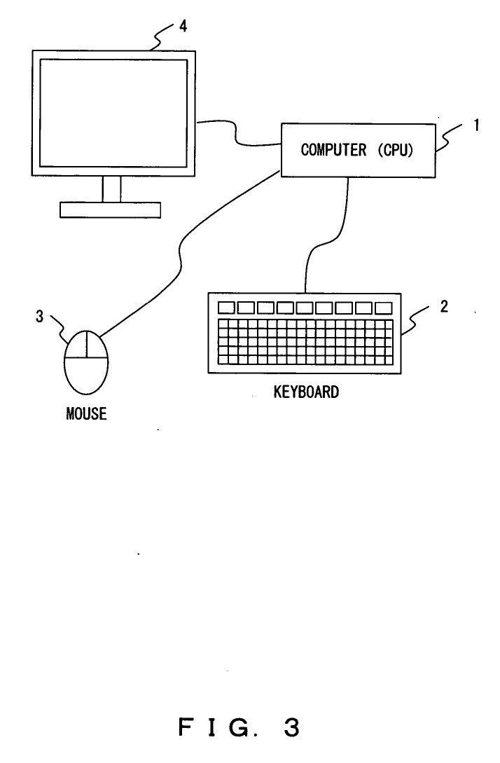

FIG. 3 is a diagram illustrating a system environment for implementation of the present invention. A computer 1 comprises a CPU and memory, and provides a function supported by a previously described program by executing the program. The computer 1 may comprise a portable recording media driver for accessing the portable recording media, and a communication I/F. A keyboard 2 and a mouse 3 are input devices of the computer 1. In other words, a user inputs data, instructions, and commands to the computer 1 using the keyboard 2 or the mouse 3. A display device 4 is an output device of the computer 1, and displays information generated by the computer 1.

In the system with the above configuration, the method relating to the present invention generates a grid for the use of software of the analysis of a physical quantity relating to the geometry of an object or a plurality of objects (hereinafter referred to as “component(s)”) defined by the computer 1.

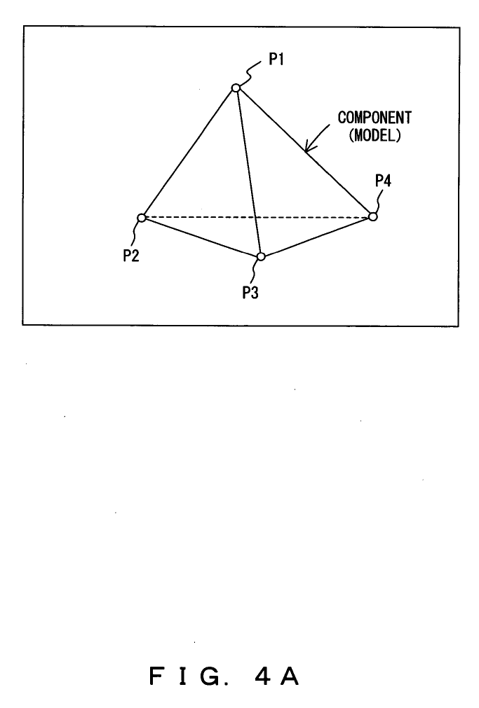

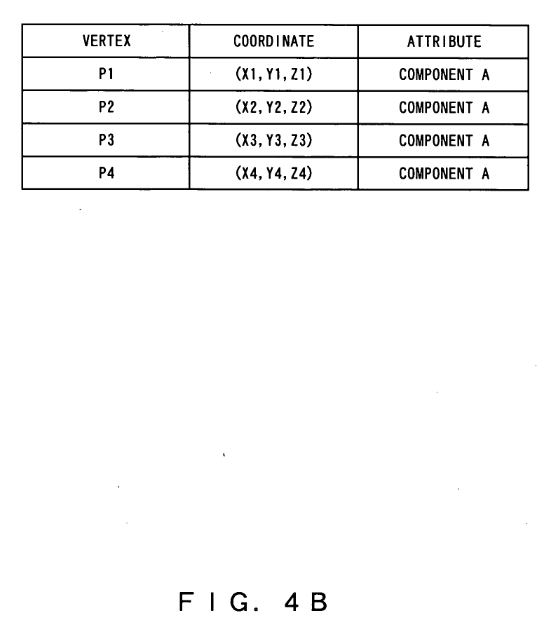

FIG. 4A is an example of a component defined by a computer. In this example, for ease of explanation, a component with a fairly simple geometry of a triangular pyramid is used. The geometry (and the orientation) of a component is defined by coordinates of a plurality of feature points by a computer. As feature points in this embodiment, vertices of a polygon constituting the component are used. In the example shown in FIG. 4A, the geometry of a component is defined by the coordinates of four vertices P1-P4 of a triangular pyramid.

FIG. 4B is an embodiment of a component definition table, which defines the geometry of a component. In this example, coordinate data and attribute data for each of four vertices P1-P4 are registered. The attribute data identifies components, to which each vertex belongs, in an analysis model comprising a plurality of components.

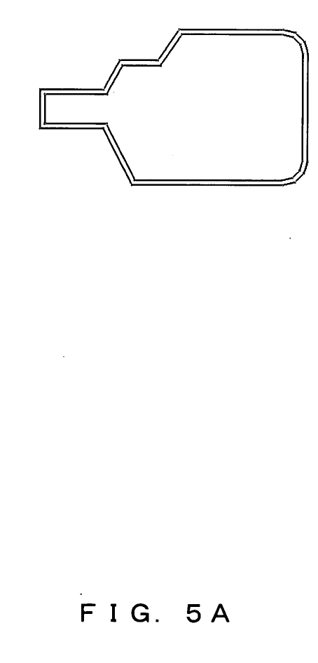

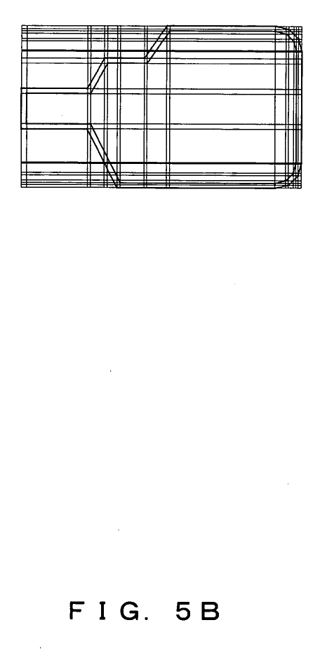

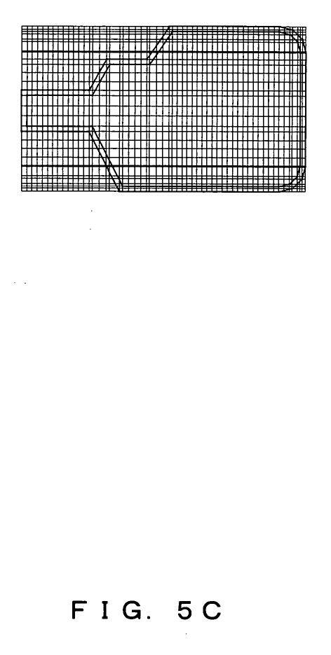

FIG. 5A through FIG. 5C are diagrams explaining an overview of a grid generation method of an embodiment of the present invention. The grid generation method of the embodiment is based on the premise that the geometry of a component is defined in advance. In this example, the geometry of a component shown in FIG. 5A has been defined.

As described in FIG. 5B, first, the base grid lines are generated. A base grid line is a grid line passing through the vertex of the component. A user, next, designates the shortest interval of the base grid line interval (an interval between adjacent base grid lines). By so doing, a base grid line, which does not meet the designated condition, is detected and deleted. In addition, the user designates the number of auxiliary grid lines to be inserted between the base grid lines (or the total number of the base grid lines and the auxiliary grid lines). By so doing, as FIG. 5C shows, the designated number of auxiliary grid lines are generated and inserted between the base grid lines. At that time, the auxiliary grid lines are arranged so that the density of grids comprising the base grid lines and the auxiliary grid lines can be made as even as possible. When inserting the auxiliary grid line between the base grid lines, the position of the base grid lines is not changed.

In the two-dimensional model, a rectangular grid is generated by performing the above procedures for each of the X direction and the Y direction. In the three-dimensional model, a cuboid grid is generated by performing the above procedure for each of the X direction, the Y direction and the Z direction. When performing the analysis, no distinction should be made between the base grid lines and the auxiliary grid lines.

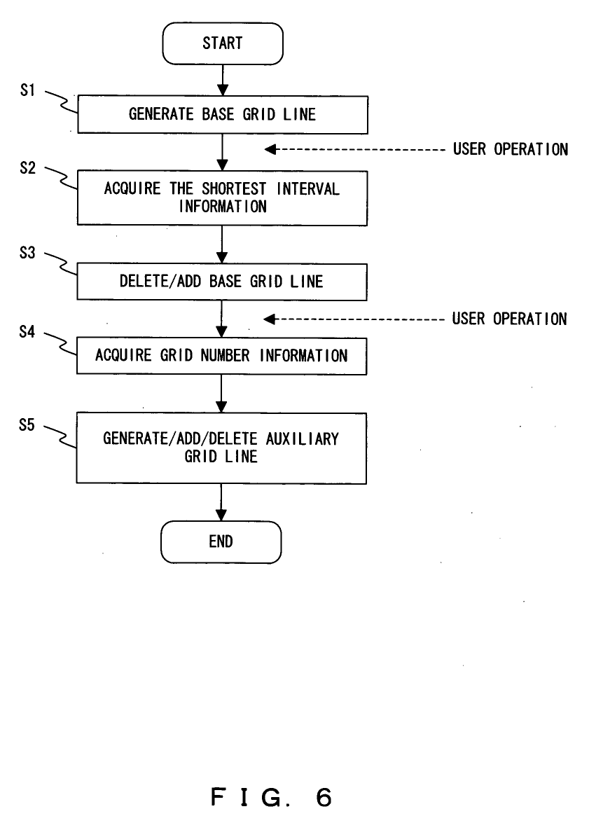

FIG. 6 is a flowchart showing an overview of the grid generation method of the embodiment. The processing of the flowchart shown in FIG. 6 is performed individually in the X direction and in the Y direction in the two-dimensional model and is performed individually in the X direction, in the Y direction and in the Z direction in the three-dimensional model.

In step S1, by detecting the coordinate of each vertex, the base grid lines are generated. In step S2, the shortest interval information designating the shortest interval of the base grid lines is acquired. The shortest interval information is input by the user. When the input is not provided by the user, a default value prepared in advance is acquired. In step S3, according to the shortest interval information, a base grid line is deleted (if needed). In other word, when the interval between two adjacent base grid lines is shorter than the shortest interval designated by the shortest interval information, one of the base grid lines is deleted. Here, it is possible to add a base grid line according to the shortest interval information. However, when the base grid lines have already been generated for all vertices, an additional base grid line cannot be added.

In step S4, grid number information, which designates the number of the auxiliary grid lines to be generated (or the number of all grid lines), is acquired. The grid number information is input by the user. When the input is not provided by the user, a default value prepared in advance is acquired. In step S5, an auxiliary grid line is generated (or added/deleted), and is inserted between the relevant base grid lines.

The grid comprises “grid lines” in the two-dimensional model, whereas the grid comprises “grid planes” in the three-dimensional model. However, in this description, for ease of explanation, the concept including the grid line and the grid plane is generally referred to as the “grid line”.

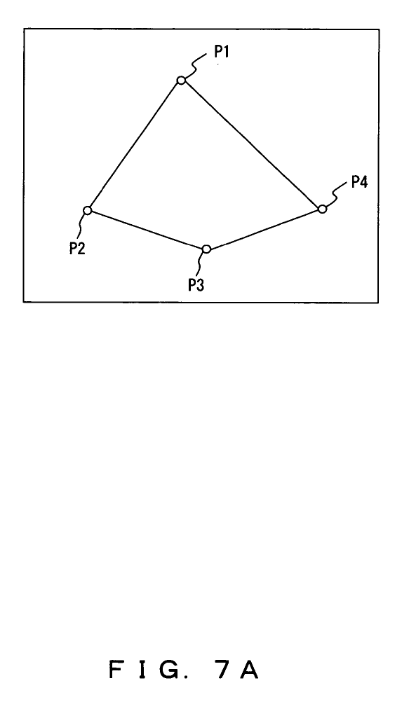

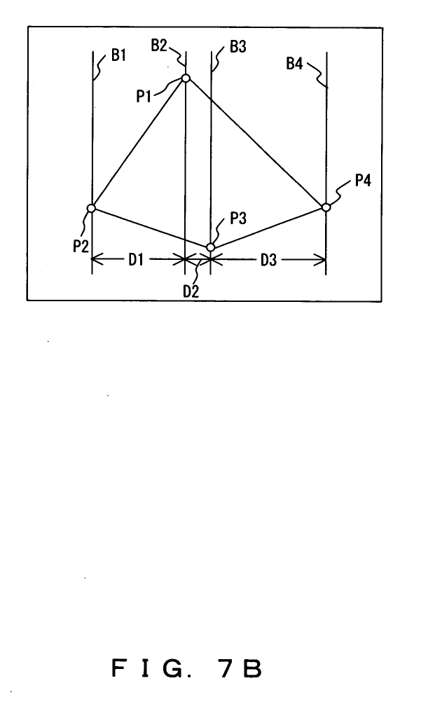

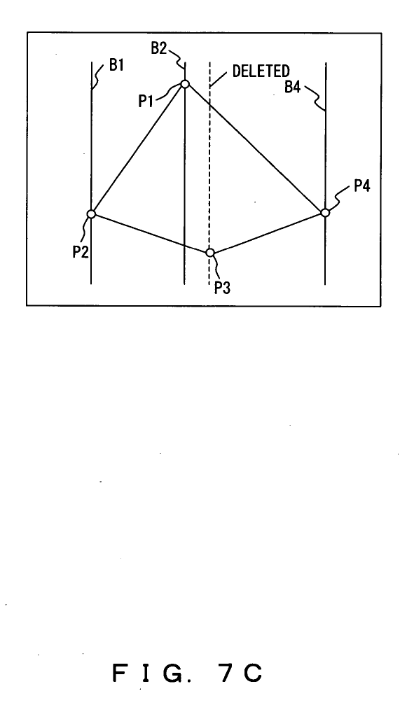

FIG. 7A through 7C are diagrams explaining generation/addition/deletion of the base grid line. This example is, for ease of explanation, based on the premise that a two-dimensional model shown in FIG. 7A is defined.

As described in FIG. 7B, first, base grid lines are generated so as to pass through each vertex. In this example, a base grid line B1 passing through a vertex P2, a base grid line B2 passing through a vertex P1, a base grid line B3 passing through a vertex P3 and a base grid line B4 passing through a vertex P4 are generated.

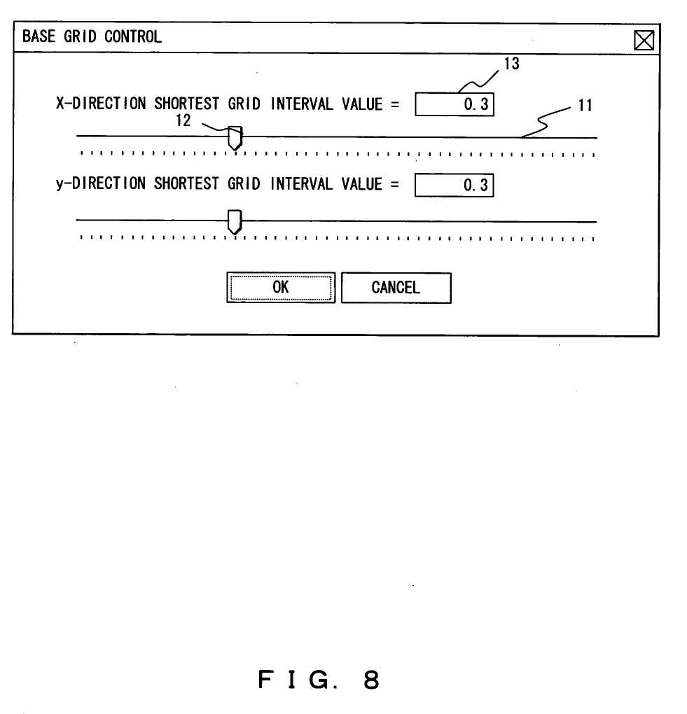

Next, a dialog box shown in FIG. 8 is displayed on the display device 4 connected to the computer 1. In FIG. 8, a slider 11 is an input device, which allows a user to input the shortest grid interval. In other words, the user can designate a desired shortest grid interval value by dragging a tab 12 of the slider 11 using the mouse 3. At that time, the slider 11 can designate any value from zero to a predetermined value. The value designated by the slider 11 is displayed in an area 13. The designation of the shortest grid interval can be individually performed in the X direction and in the Y direction. The user can input a desired shortest grid interval directly in the area 13 using the keyboard 2.

When the shortest grid interval is designated, in FIG. 7B, each of intervals D1, D2 and D3 between the base grid lines adjacent to each other is individually compared with the shortest interval value. In this case, all of the intervals D1, D2 and D3 are longer than the designated shortest interval value, and the base grid line should not be deleted. However, if the interval D2, for example, is shorter than the designated shorted grid interval value, one of the base grid lines (the base grid line B3, in this example) is deleted, as shown in FIG. 7C.

If the user changes the shortest grid interval value after the base grid line is deleted as described above, and the changed shorted grid interval value is shorter than the interval D2, the base grid line B3 is added and the arrangement of the grid is in the original state shown in FIG. 7B.

As described above, in the grid generation method of the embodiment, the base grid line is automatically deleted or added after the base grid line is generated, based on the shortest grid interval value designated by the user. Consequently, the method prevents the grid from becoming finer than necessary, and also prevents deterioration of the aspect ratio of a cell formed by the grid. As a result, accuracy of the analysis performed using the grid is improved. User-friendliness is achieved by the fact that a simple operation of the slider allows the user to designate the shortest grid interval value.

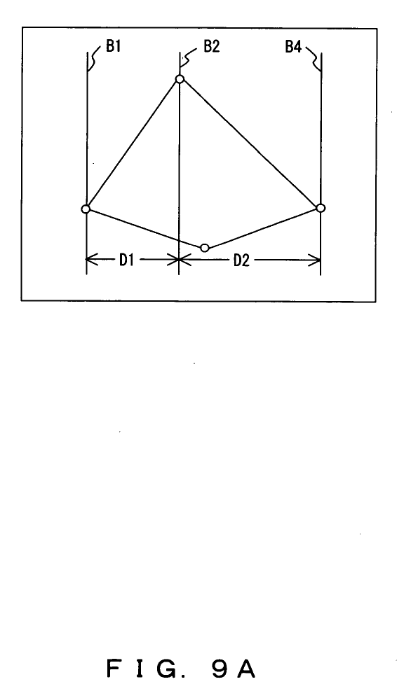

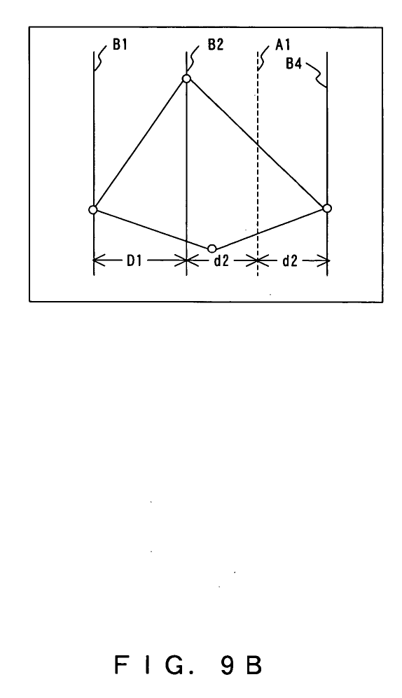

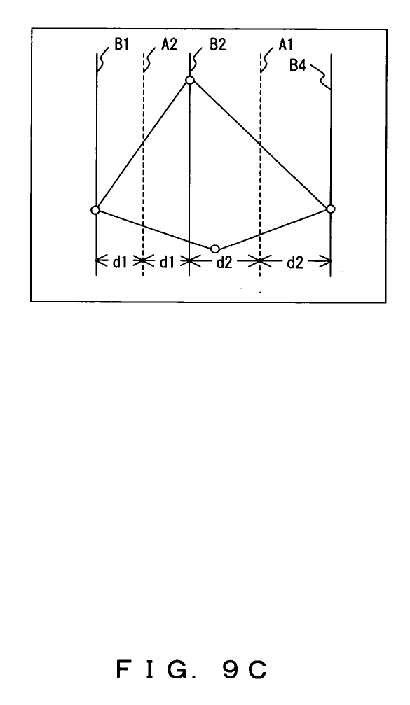

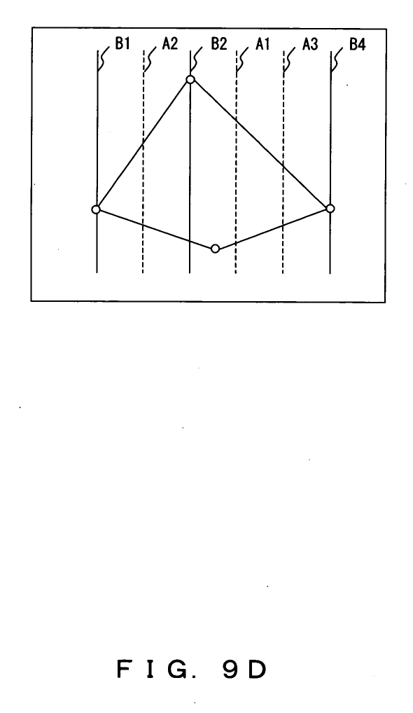

FIG. 9A through 9D are diagrams explaining generation/addition/deletion of the auxiliary grid line. This example is based on the premise that the state shown in FIG. 9A is acquired by the procedures explained with reference to FIG. 7A through 7C and FIG. 8. That is, the base grid lines B1, B2 and B4 have been generated.

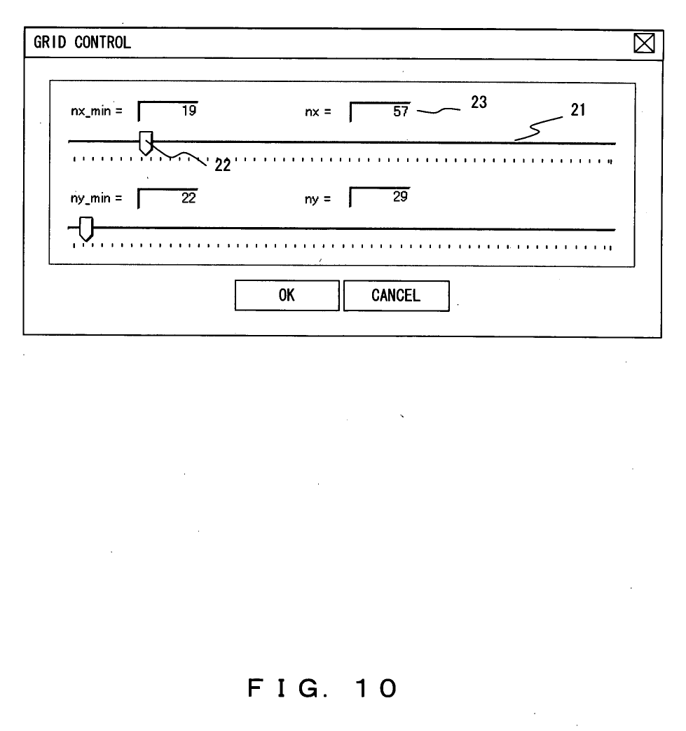

A dialog box shown in FIG. 10 is displayed on the display device 4 connected to the computer 1. In FIG. 10, a slider 21 is an input device, which allows a user to input the number of grid lines. In other words, the user can designate a desired number of grid lines by dragging a tab 22 of the slider 21 using the mouse 3. At that time “the number of grid lines” that the user designates can be the number of auxiliary grid lines or can be the total of the number of base grid lines and the number of auxiliary grid lines. The number of the smallest grid lines (nx_min and ny_min) is “zero” for the former, and is “the number of the base grid lines” for the latter.

The slider 21 can designate any value from the smallest number of lines to a predetermined value. The value designated by the slider 21 is displayed in an area 23. The designation of the number of grid lines can be performed individually in the X direction and in the Y direction. It is also possible for the user to input a desired number of grid lines directly into the area 23 using the keyboard 2.

The auxiliary grid line is inserted into the region where the grid interval is the longest. When a plurality of the auxiliary grid lines are generated each auxiliary grid line is inserted in descending order of grid interval. In the following description, a case in which three auxiliary grid lines are inserted is explained.

In FIG. 9A, the grid interval D2 is larger than the grid interval D1. Therefore, in such a case, the first auxiliary grid line A1 is arranged at an intermediate position between the base grid lines B2 and B4, as shown in FIG. 9B. As a result, both the interval between the base grid line B2 and the auxiliary grid line A1 and the interval between the base grid line B4 and the auxiliary grid line A1 is d2 (=D2/2).

In FIG. 9B, the grid interval D1 is longer than the grid interval d2. Therefore, in such a case, the second auxiliary grid line A2 is arranged in an intermediate position between the base grid lines B1 and B2, as shown in FIG. 9C. At that time, the interval d1 is half of the interval D1.

In addition, in FIG. 9C, the grid interval d2 is longer than the grid interval d1. In such a case, a third auxiliary grid line A3 is arranged between the base grid lines B2 and B4, as shown in FIG. 9D. At that time, the auxiliary grid line A1 has been already inserted between the base grid lines B2 and B4. Therefore, in such a case, the auxiliary grid lines A1 and A3 are arranged so as to divide the region between the base grid lines B2 and B4 equally into three.

As described above, in the grid generation method of the embodiment, the designation of the number of grid lines alone enables arrangement of the grid lines at essentially equal intervals. In other words, a grid with homogenous spacing throughout the entire range can be generated without concerning users of complicated operations.

In the following description, details of the grid generation method of the embodiment are set forth.

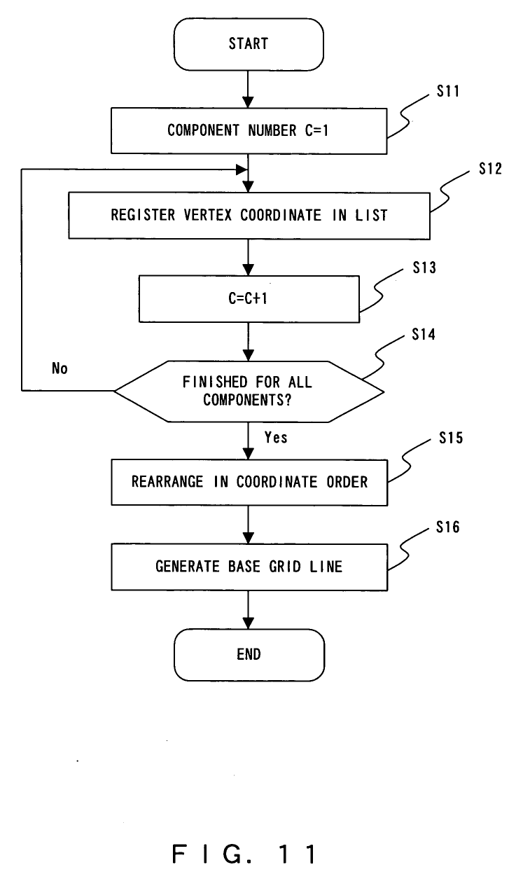

FIG. 11 is a flowchart of for generating a base grid line. The processing of this flowchart is equivalent to step S1 in FIG. 6.

In step S11, a variable C for sequentially defining components is initialized. In step S12, coordinate data of each vertex of a specified component is acquired from the component definition table, and is registered in a list. In step S13, the next component is specified by incrementing the variable C. In step S14, whether or not any component, on which the processing of step S12 is to be performed, remains is checked. If such a component remains, the process returns to step S12; however, if the processing of step S12 is finished for all components, the process proceeds to step S15.

In step S15, coordinate data is rearranged in ascending order of the coordinate data for each of the X coordinates, the Y coordinates and the Z coordinates, and is registered in a grid table. Base grid lines are generated according to the grid table in step S16. By so doing, base grid lines passing through each vertex are generated.

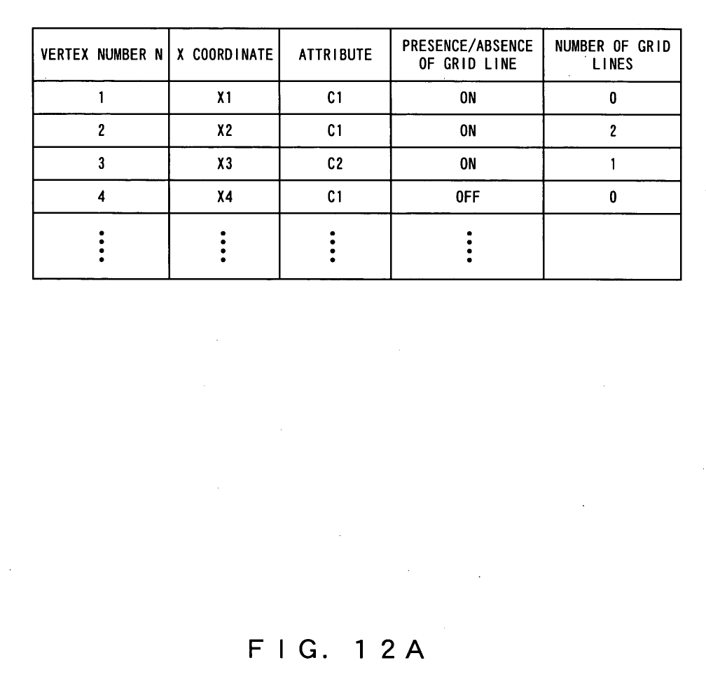

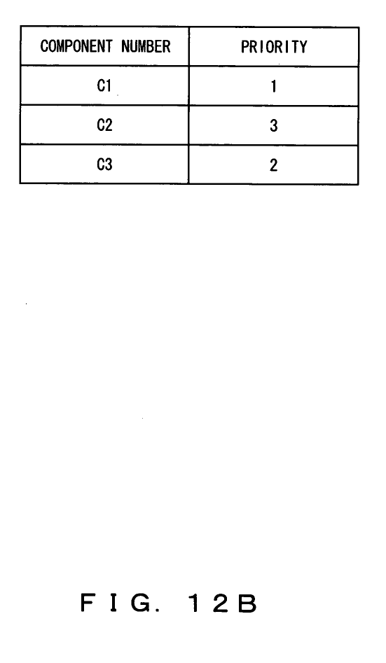

FIG. 12A is an embodiment of the grid table. A grid table is generated for each of the X-axis, Y-axis and Z-axis, for example; however, each has the same data structure.

In FIG. 12A, “vertex number N” identifies each vertex. In this example, the “vertex number N” is assigned in the order of the coordinates. “Coordinate” is the coordinate of each vertex. “Attribute” identifies a component to which each vertex belongs. In this example, vertices with vertex numbers of N=1, 2, 4 belong to a component C1, and a vertex with a vertex number of N=3 belongs to a component C2. “Presence/absence of grid line” indicates whether a base grid line passing through a vertex is present or absent. In this example, each of vertices with vertex numbers of N=1, 2, 3 has a base grid line. “Number of grid lines” indicates the number of auxiliary grid lines present between the adjacent base grid lines. In this example, auxiliary grid lines are absent between the first base grid line and the second base grid line; however two auxiliary grid lines are present between the second base grid line and the third grid line. An explanation of updating the “Presence/absence of grid line” and “Number of grid lines” is provided later.

In the grid generation method of the present embodiment, when there is a plurality of components, the user can assign a priority to each component. The priority of each component is registered in a priority table shown in FIG. 12B.

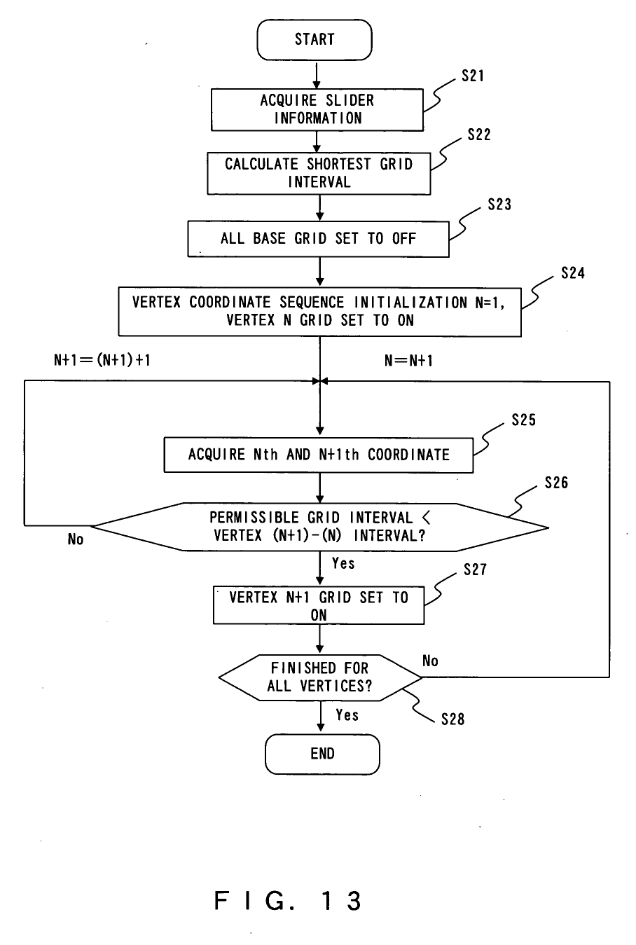

FIG. 13 is a flowchart of processing for deleting/adding a base grid line. The processing of this flowchart is equivalent to steps S2 and S3 in FIG. 6. The processing is performed when the user operates the slider 11 shown in FIG. 8. Additionally, a variable N is a vertex number explained with reference to FIG. 12A.

In step S21, a user instruction input using the slider 11 is acquired. That is, the position of the tab 12 is detected. In step S22, the shortest grid interval is calculated based on the position of the tab 12. In step S23, all base grid lines are set to an OFF state. In other words, in the grid table shown in FIG. 12A, OFF is set in the “Presence/absence of grid line” for all vertices.

In step S24, in the grid table, ON is set in a record for “variable N=1” as the “Presence/absence of grid line”. By so doing, a first base grid line is generated.

In step S25, the coordinates of the Nth and the N+1th vertices are acquired from the grid table. In step S26, first, the difference between the coordinates of the Nth and the N+1th vertices (i.e. the interval) is calculated. This interval and the shortest grid interval calculated in step S22 are compared. When the result shows that the interval between the Nth vertex and the N+1th vertex is shorter than the shortest grid interval, “N+1” is incremented, while “N” is fixed and the process returns to step S25. By so doing, the interval between the Nth vertex and the N+2th vertex can be compared with the shortest grid interval. steps S25 and S26 are carried out, subsequently, until a vertex bearing a longer interval than the shortest grid interval is found.

In step S27, ON is set in “Presence/absence of grid line” of the grid table for all vertices detected in steps S25 and S26. By so doing, a base grid line passing through a vertex, which satisfies the condition of step S26 is generated. In step S28, whether or not steps S25 through S27 have been performed on all vertices is checked. If any unprocessed vertex remains, the process returns to step S25 after incrementing the variable N.

In such a way, according to the grid generation method of the present embodiment, a base grid line is generated so as to prevent the interval of the base grid lines from being smaller than the shortest grid interval designated by a user. In other words, when the user reduces the shortest grid interval by operating the slider 11, base grid lines are deleted so as to meet the above conditions, as necessary. Meanwhile, when the user increases the shortest grid interval by operating the slider 11, base grid lines are added within a range, which meets the above conditions, as necessary. It is desirable that the drawing of the base grid line on the display device 4 is performed in real time upon operation of the slider 11.

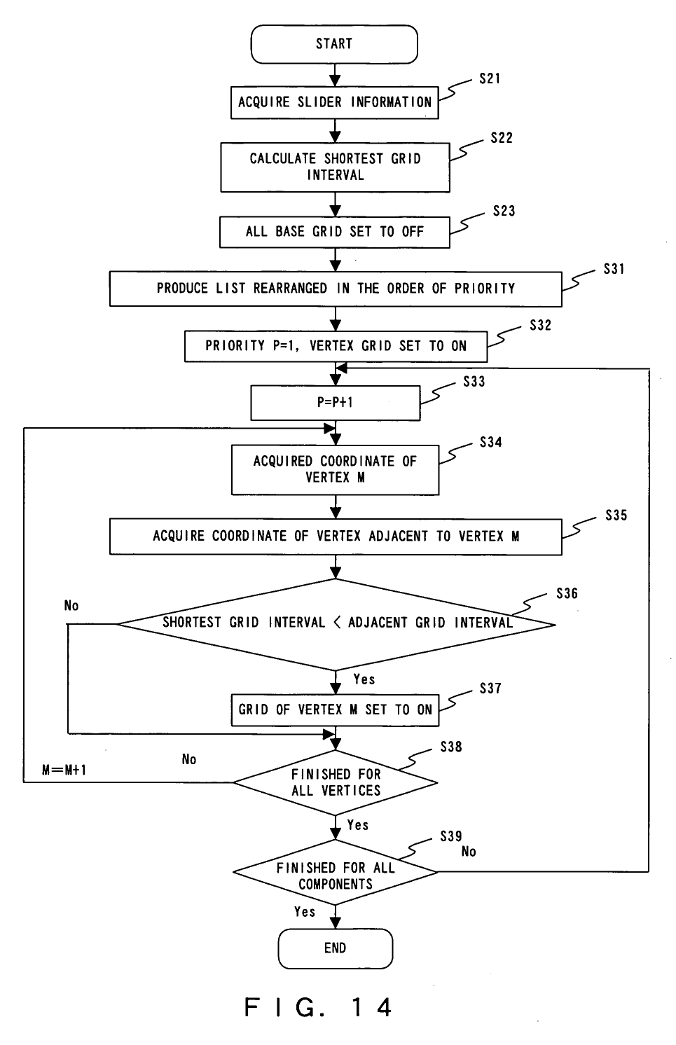

FIG. 14 is a flowchart of processing for deleting/adding base grid lines in consideration of the component priority. This example is based on the premise that the priority table shown in FIG. 12B is prepared in advance. The processing of steps S21 through S23 is the same as the processing explained with reference to FIG. 13.

In step S31, with reference to the priority table, a list, which rearranges the data relating to each vertex according to priority, is produced. In step S32, processing in a flowchart shown in FIG. 13 is performed on each vertex of the component with the highest priority, and one or more base grid lines are generated.

In step S33, the next component is selected according to its priority. In the following description, each vertex belonging to a component selected in step S33 is represented by a variable M. In step S34, the coordinate of the Mth vertex is acquired. In step S35, with reference to the grid table, the coordinates of vertices (both a vertex on the positive side and a vertex on the negative side) adjacent to the Mth vertex are acquired. At that time, a vertex adjacent to the Mth vertex is extracted from among the vertices of which the grid line setting is ON.

In step S36, the interval between the Mth vertex and the adjacent vertex is compared with the shortest grid interval. When both the interval between the Mth vertex and the adjacent vertex on the positive side and the interval between the Mth vertex and the adjacent vertex on the negative side are longer than the shortest grid interval, the grid of the Mth vertex is set to ON in step S37. By so doing, a grid passing through the Mth vertex is generated. Step S38 is established to perform processing in steps S34 through S37 for all vertices belonging to the selected component. Step S39 is established to perform processing in steps S34 through S37 for all components.

As described above, according to the processing in the flowchart, when deletion of a base grid line is necessary, a base grid line, which passes through a vertex of a component with low priority, is to be deleted. Therefore, the accuracy of the analysis relating to a component with high priority is not decreased. It is desirable that the drawing of the base grid line on the display device 4 is performed in real time upon the operation of the slider 11.

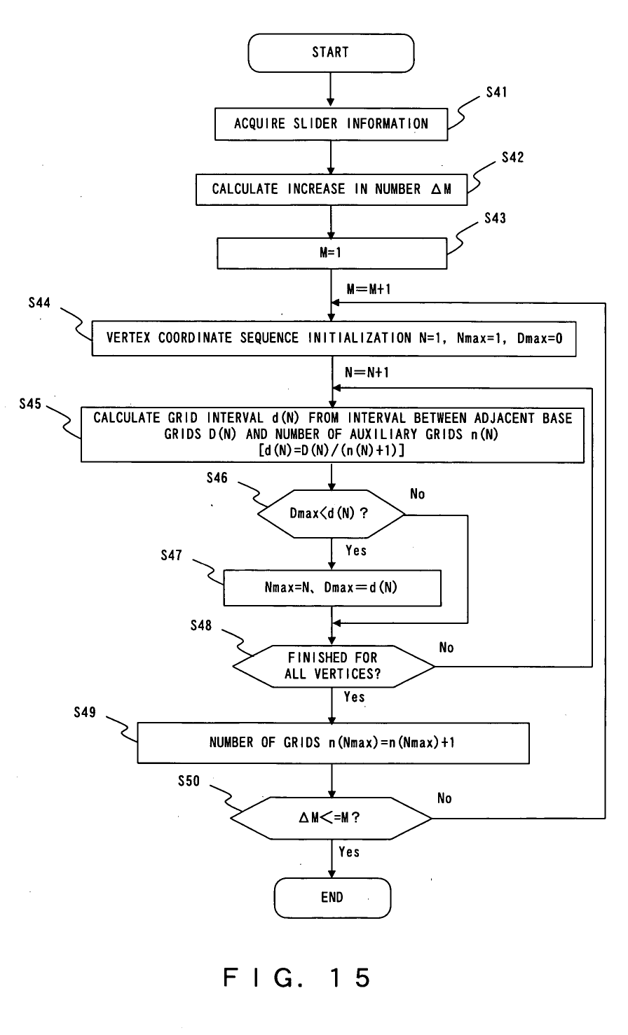

FIG. 15 is a flowchart of processing for increasing the number of auxiliary grid lines. The processing of this flowchart is equivalent to the processing in steps S4 and S5 in FIG. 6. The processing is performed when the user operates the slider 21 shown in FIG. 10.

In step S41, an instruction input by the user using the slider 21 is acquired. That is, change in the position of the tab 22 is detected. In step S42, the number of auxiliary grid lines to be added or to be deleted (the increased number ΔM) is calculated based on the direction of movement and the distance of movement of the tab 22. In this description, the tab 22 of the slider 21 in FIG. 10 is moved toward the right direction by the user, causing auxiliary grid lines to be added. In step S43, a variable M for counting the auxiliary grid lines to be added is initialized.

Steps S44 through S48 are processing for detecting the region where the grid interval is the longest. In step S44, a variable N for identifying vertices, a variable Nₘₐₓ for identifying a vertex of which the interval to the adjacent vertex is the longest, and a variable Dₘₐₓ representing the interval value corresponding to the variable Nₘₐₓ are initialized. In step S45, a grid interval d(N) between the base grid line passing through the Nth vertex (hereinafter referred to as the base grid line N) and its adjacent base grid line (hereinafter referred to as the base grid line N+1) is calculated. The equation used for the calculation is “d(N)=D(N)/{n(N)+1}”. D(N) represents the interval between the base grid line N and the base grid line N+1. n(N) represents the number of auxiliary grid lines which have previously arranged between the base grid line N and the base grid line N+1. In step S46, the newly calculated grid interval d(N) is compared with the maximum value of the grid interval Dₘₐₓ, which was previously calculated. When the newly calculated grid interval d(N) is longer than the Dₘₐₓ, then, the maximum value Dₘₐₓ is updated.

In step S49, the grid number in the region where the grid interval is the longest is incremented. In other words, when the grid interval in a region between the Nth vertex and the N+1th vertex is the longest, “1” is added to the grid number of the record of the Nth vertex in the grid table shown in FIG. 12A. Step S50 is set so as to repeat the processing of steps S44 through S49 until the ΔM of the auxiliary grid lines are added.

In such a way, according to the grid generation method of the present embodiment, upon receiving an instruction to increase the number of grid lines, the region where the grid interval is the longest is detected, and the new auxiliary grid line is automatically added to the region. Thus, a grid with homogenous spacing throughout the entire range can be acquired while reducing the burden on the user.

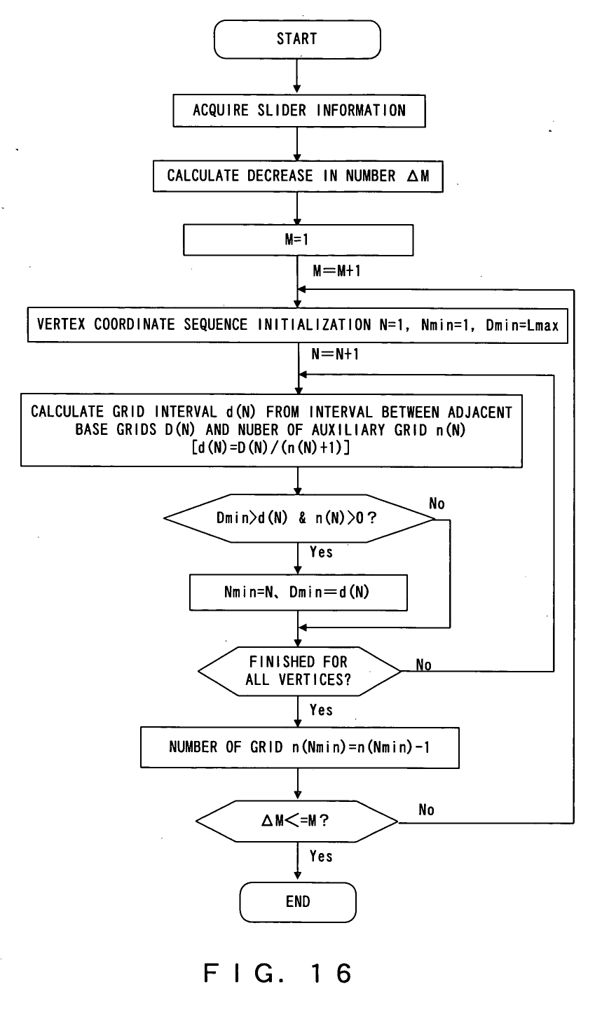

FIG. 16 is a flowchart of processing for reducing the number of auxiliary grid lines. The flow of the processing for reducing the number of auxiliary grid lines is basically the same as the processing for increasing the number of auxiliary grid lines. However, in the processing for reducing the number of auxiliary grid lines, a region where the grid interval is the shortest is detected, and the existing auxiliary grid line is automatically deleted from the region.

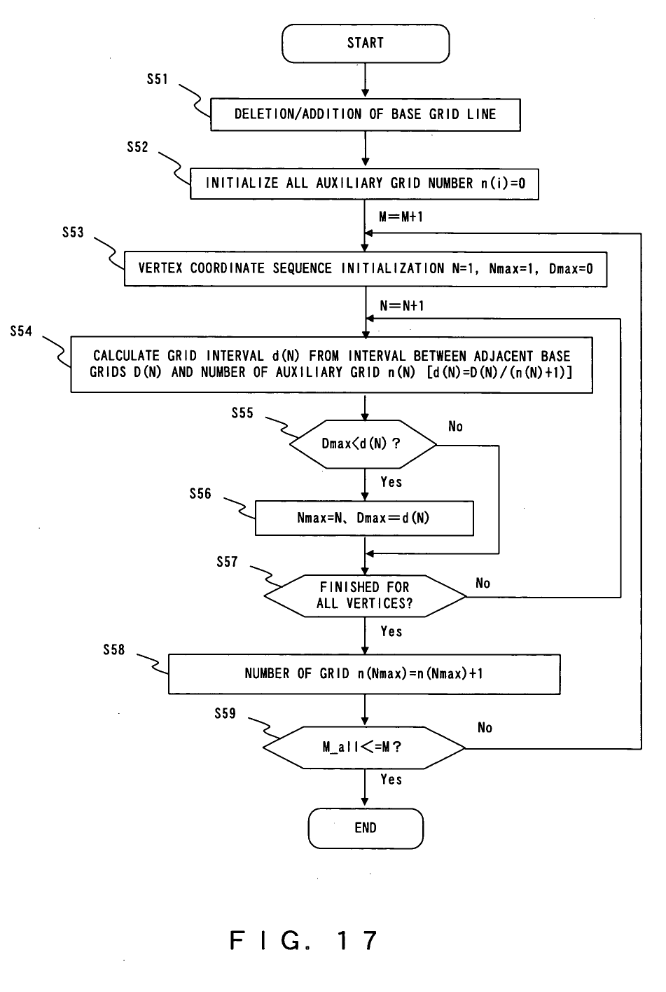

FIG. 17 is a flowchart of processing for drawing a grid after a change in the interval of the base grid lines. This processing is performed when the slider 11 shown in FIG. 8 is operated by a user in a state that more than one auxiliary grid line has been generated and inserted between the base grid lines. In the following explanation, the total number of grid lines (excluding the deleted base grid line) is “M_all”.

In step S51, the total number of grid lines M_all is calculated along with the deletion or addition of base grid lines in response to the operation of the slider 11. The processing of deleting or adding base grid lines is the same as in the explanation provided with reference to FIG. 13 or FIG. 14.

In step S52, the variable n, representing the total number of the auxiliary grid lines inserted between the base grid lines, is initialized. Processing in steps S53 through S58 is basically the same as the processing in steps S44 through S49. That is, a region where the grid interval is the longest is detected, and the number of auxiliary grid lines to be incremented n(i) in the region is determined. Then using step S59, the processing in steps S53 through S58 is repeatedly performed until the variable M for counting the grid lines reaches the total number M_all.

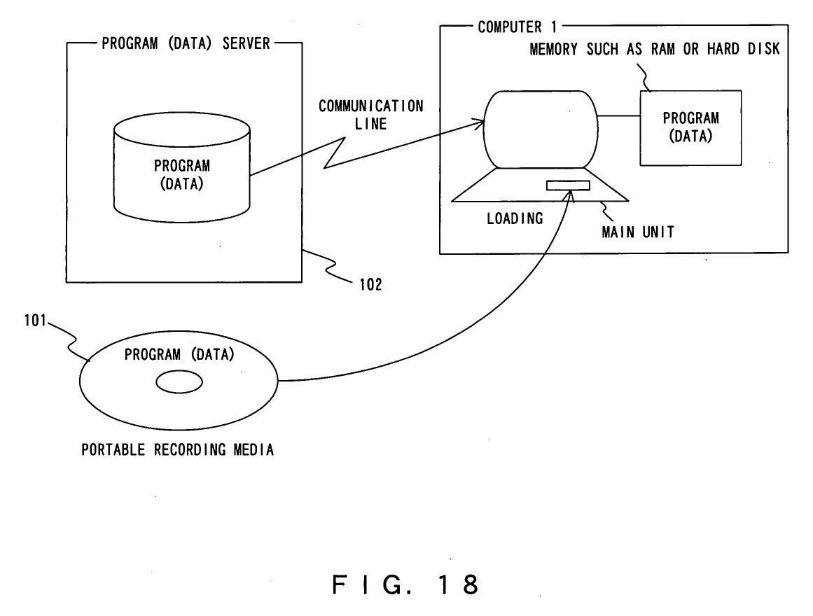

The above functions or procedures are realized by executing a program, in which the process shown in the above flowcharts is described, by a computer. The program relating to the present invention is provided by a method shown in FIG. 18, for example.

(1) Provided after being installed in the computer 1. In such a case, the program is preinstalled in the memory of the computer 1 before the shipping of the computer, for example.

(2) Provided after being stored in the portable recording media 101. In such a case, the program stored in the portable recoding media is basically installed in a memory device via a recording media driver. A semiconductor assembly (such as a PC card), media to which information is input/output by magnetic effects (such as a flexible disk or magnetic tape), and media to which information is input/output optically (such as an optical disk) are appropriate for the portable recording media 101.

(3) Provided from a program server 102 provided in a network. In such a case, the computer 1 acquires an appropriate program by downloading from a program server 102. Alternatively, the computer 1 can use programs stored on the program server 102 without downloading them.

What is claimed is:

1. A computer readable recording medium storing a program for generating a grid for the use of an analysis of a physical quantity relating to the geometry of an object using a computer, said program comprising:
generating a plurality of base grid elements, each of which passes through each of a plurality of feature points, which specify the geometry of the object; and
generating an auxiliary grid element of the number designated by grid element number information and arranging the generated auxiliary grid element between the base grid elements.

2. The recording medium according to claim 1, wherein said program further comprises a step of adding or deleting the base grid element according to the shortest interval information, which designates the shortest interval of the base grid elements.

3. The recording medium according to claim 2, wherein the shortest interval information is input by a user using a slider displayed on a display device of the computer.

4. The recording medium according to claim 2, wherein the base grid element is deleted or added in real time in response to the change in the shortest interval information.

5. The recording medium according to claim 2, wherein generation, deletion, and addition of a base grid element are performed on each of an X-Y plane, a Y-Z plane and a Z-X plane, on which the object is projected.

6. The recording medium according to claim 2, wherein said program further comprises a step of deleting or adding the base grid element in accordance with the priority assigned to each of a plurality of objects.

7. The recording medium according to claim 1, wherein the grid element number information is input by a user using a slider displayed on a display device of the computer.

8. The recording medium according to claim 1, wherein the auxiliary grid element is deleted or added in real time in response to the change in the grid element number information.

9. The recording medium according to claim 1, wherein the generation, deletion and addition of the auxiliary grid element are performed on each of an X-Y plane, a Y-Z plane and Z-X plane, on which the object is projected.

10. The recording medium according to claim 1, wherein when adding the auxiliary grid element in response to change in the grid element number information, the auxiliary grid element is inserted in a region where the grid interval is the longest.

11. The recording medium according to claim 10, wherein when a new auxiliary grid element is inserted between a first base grid element and a second base grid element, one or a plurality of auxiliary grid element is arranged so that a region between the first base grid element and the second base grid element is evenly divided by said one or a plurality of the auxiliary grid element.

12. The recoding medium according to claim 1, wherein when deleting an auxiliary grid element in response to change in the grid element number information, the auxiliary grid element is deleted from a region where the grid interval is the shortest.

13. The recording medium according to claim 12, wherein when an auxiliary grid element is deleted from a region between a first base grid element and a second base grid element where a plurality of auxiliary grid elements are present, one or a plurality of the remaining auxiliary grid element is arranged so that the region between the first base grid element and the second base grid element is evenly divided by the remaining auxiliary grid element.

14. A grid generation method for generating a grid for the use of an analysis of a physical quantity relating to the geometry of an object using a computer, comprising:
generating a plurality of base grid elements, each of which passes through each of a plurality of feature points, which specify the geometry of the object; and
generating an auxiliary grid element of the number designated by grid element number information and arranging the generated auxiliary grid element between the base grid elements.

15. The grid generation method according to claim 14, wherein the base grid element is deleted or added according to shortest interval information, which designates the shortest interval of the base grid elements.

16. A grid generation device for generating a grid for the use of an analysis of a physical quantity relating to the geometry of an object using a computer, comprising:
a base grid generator which generates a plurality of base grid elements, each of which passes through each of a plurality of feature points, which specify the geometry of the object; and
an auxiliary grid generator which generates an auxiliary grid element of the number designated by grid element number information and arranges the generated auxiliary grid element between the base grid elements.

17. The grid generation device according to claim 16, further comprising:
a deletion/addition unit which deletes or adds the base grid element according to shortest interval information, which designates the shortest interval of the base grid elements.
